(19) United States
(12) Patent Application Publication
(10) Pub. No.: US 2020/0010715 A1
(43) Pub. Date: Jan. 9, 2020

(54) SOLUTION FOR FORMING SURFACE PROTECTIVE RESIN MEMBER, SOLUTION SET FOR FORMING SURFACE PROTECTIVE RESIN MEMBER, AND SURFACE PROTECTIVE RESIN MEMBER

(71) Applicant: FUJI XEROX CO., LTD., Tokyo (JP)

(72) Inventor: Hisae YOSHIZAWA, Minamiashigara-shi (JP)

(73) Assignee: FUJI XEROX CO., LTD., Tokyo (JP)

(21) Appl. No.: 16/157,898

(22) Filed: Oct. 11, 2018

(30) Foreign Application Priority Data
Jul. 4, 2018 (JP) 2018-127859

(51) Int. Cl. C09D 133/14; C09K 3/16

(52) U.S. Cl. CPC C09D 133/14; C09K 3/16

(57) ABSTRACT

Provided is a solution for forming a surface protective resin member, containing: an acrylic resin having a hydroxyl value of 40 to 280; a polyol having a plurality of hydroxyl groups bonded via a carbon chain having 6 or more carbon atoms; and a silicone resin having a functional group reactive to an isocyanate group.

### CROSS-REFERENCE TO RELATED APPLICATIONS

This application is based on and claims priority under 35 USC 119 from Japanese Patent Application No. 2018-127859 filed on Jul. 4, 2018.

### BACKGROUND

### Technical Field

The present invention relates to a solution for forming a surface protective resin member, a solution set for forming a surface protective resin member, and a surface protective resin member.

### Related Art

Conventionally, in various fields, from the viewpoint of suppressing scratches on the surface, a surface protective resin member such as a surface protective film is provided. Examples of applications of the surface protective resin member include protective films for protecting screens and bodies other than screens in portable devices such as mobile phones and portable game machines, car bodies and door handles, an exterior of a piano, various members of an image forming device (for example, an intermediate transfer member), or the like.

For example, JP-A-2012-025821 discloses “a urethane resin formed by polymerizing: an acrylic resin containing a hydroxyl group; and an isocyanate, wherein the Martens hardness at 150° C. is 1 N/mm² to 200 N/mm², and the return rate at 150° C. is 80% to 100%”.

JP-A-2007-009218 discloses “a coating composition containing a polydimethylsiloxane copolymer, a caprolactone and a siloxane as essential components, wherein the siloxane and the caprolactone are introduced into the skeleton of the polydimethylsiloxane copolymer”.

JP-A-2007-002260 discloses “a coating composition containing a polydimethylsiloxane copolymer, a caprolactone and a siloxane as essential components, wherein the caprolactone is introduced into the skeleton of the polydimethylsiloxane copolymer”.

JP-A-2007-009219 discloses “a coating composition containing a polydimethylsiloxane copolymer, a caprolactone and a siloxane as essential components, wherein the siloxane is introduced into the skeleton of the polydimethylsiloxane copolymer”.

JP-A-H11-228905 discloses “a coating composition containing a polydimethylsiloxane copolymer, a polycaprolactone, and a polysiloxane as essential components, wherein the polycaprolactone and the polysiloxane are each introduced into the skeleton of the polydimethylsiloxane copolymer or are present individually in the coating composition”.

JP-A-2001-011376 discloses “a surface functional material obtained by curing a composition and/or a compound containing a polydimethylsiloxane copolymer, a polycaprolactone and a polysiloxane as constituent elements”.

### SUMMARY

Aspect of non-limiting embodiments of the present disclosure relates to provide a solution for forming a surface protective resin member which is capable of forming a surface protective resin member having a self-repairing property and a low surface friction coefficient when mixed with a solution containing a polyfunctional isocyanate and cured, compared with a solution for forming a surface protective resin member containing only an acrylic resin having a hydroxyl value of 40 to 280 and a polyol having a plurality of hydroxyl groups bonded via a carbon chain having 6 or more carbon atoms.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the invention, there is provided a solution for forming a surface protective resin member, containing:

an acrylic resin having a hydroxyl value of 40 to 280;

a polyol having a plurality of hydroxyl groups bonded via a carbon chain having 6 or more carbon atoms; and

a silicone resin having a functional group reactive to an isocyanate group.

### DETAILED DESCRIPTION

Hereinafter, exemplary embodiments of the present invention are described. The present embodiment is one example of implementing the present invention, and the present invention is not limited to the following embodiments.

### <Solution for Forming Surface Protective Resin Member>

The solution for forming a surface protective resin member (hereinafter simply referred to as “solution set”) according to the present embodiment contains: an acrylic resin having a hydroxyl value of 40 to 280 (hereinafter simply referred to as “specific acrylic resin”); a polyol having a plurality of hydroxyl groups bonded via a carbon chain having 6 or more carbon atoms (hereinafter simply referred to as “long-chain polyol”); and a silicone resin having a functional group reactive to an isocyanate group (hereinafter simply referred to as “isocyanate group reactive-silicone resin”).

In the present specification, the unit of the hydroxyl value is “mgKOH/g”, but this unit may be omitted.

The solution for forming a surface protective resin member according to the present embodiment is mixed with a solution containing a polyfunctional isocyanate and cured to be used, that is, the solution is used as a material for forming a surface protective resin member containing a polyurethane resin. Since the solution for forming a surface protective resin member according to the present embodiment contains the above configuration, a surface protective resin member having a self-repairing property and a low surface friction coefficient can be formed.

The reasons for this are presumed as follows.

The resin to be synthesized when the solution for forming a surface protective resin member according to the present embodiment (hereinafter simply referred to as “A solution”) and the solution containing a polyfunctional isocyanate (hereinafter simply referred to as “B solution”) are mixed and cured is described.

In a case where an A solution containing a specific acrylic resin (a), a long-chain polyol (b) and an isocyanate group reactive-silicone resin (c) and a B solution containing a multifunctional isocyanate (d) are mixed and cured, the OH group of (a), the OH group of (b) and the functional group in (c) react with and bond to the multifunctional isocyanate (d). Therefore, a structure in which the silicone resin (c) is bonded to the side chain of the specific acrylic resin (a) via the polyfunctional isocyanate (d), or a structure in which the silicone resin (c) is bonded to the side chain of the specific acrylic resin (a) via the polyfunctional isocyanate (d) and the long-chain polyol (b) is formed. Further, a polyurethane in which the specific acrylic resin (a) is crosslinked via the long-chain polyol (b) and the polyfunctional isocyanate (d) is synthesized.

Accordingly, the specific acrylic resin (a) forms a crosslink via the long-chain polyol (b) and the polyfunctional isocyanate (d), and thereby the formed surface protective resin member is considered to exert a self-repairing property. In addition, it is considered that a silicone side chain can be introduced into a urethane by reacting the specific acrylic resin (a) with the isocyanate group reactive-silicone resin (c) via the polyfunctional isocyanate (d), and thereby the friction coefficient of the surface protective resin member is reduced.

In the present embodiment, a surface protective resin member having a self-repairing property and a low surface friction coefficient is thus formed.

Next, each component constituting the solution (A solution) for forming a surface protective resin member according to the present embodiment is described in detail.

(a) Specific Acrylic Resin

In the present embodiment, a specific acrylic resin having a hydroxyl group (—OH) is used as the acrylic resin. The specific acrylic resin has a hydroxyl value of 40 mgKOH/g to 280 mgKOH/g.

The specific acrylic resin having a hydroxyl group includes those having a carboxy group in addition to those having a hydroxyl group in the molecular structure.

The hydroxyl group is introduced, for example, by using a monomer having a hydroxyl group as a monomer to be a raw material of the specific acrylic resin. Examples of the monomer having a hydroxyl group include (1) an ethylenic monomer having a hydroxy group, such as hydroxymethyl (meth)acrylate, hydroxyethyl (meth)acrylate, hydroxypropyl (meth)acrylate, hydroxybutyl (meth)acrylate, and N-methylolacrylamide.

In addition, (2) an ethylenic monomer having a carboxy group, such as (meth)acrylic acid, crotonic acid, itaconic acid, fumaric acid, and maleic acid may be used.

Further, a monomer not having a hydroxyl group may be used in combination with the monomer having a hydroxyl group to be a raw material of the specific acrylic resin. Examples of the monomer not having a hydroxyl group include an ethylenic monomer copolymerizable with the monomers (1) and (2), for example, alkyl (meth)acrylates such as methyl (meth)acrylate, ethyl (meth)acrylate, n-propyl (meth)acrylate, n-butyl (meth)acrylate, isobutyl (meth)acrylate, 2-ethylhexyl (meth)acrylate, n-octyl (meth)acrylate and n-dodecyl (meth)acrylate.

In the present specification, the term “(meth) acrylic acid” is a concept encompassing both acrylic acid and methacrylic acid. The term “(meth)acrylate” is a concept encompassing both acrylate and methacrylate.

Fluorine Atom

It is preferable that the specific acrylic resin contains a fluorine atom in the molecular structure. Since the fluorine atom is contained in the specific acrylic resin, a surface protective resin member having an enhanced antifouling property and a low surface friction coefficient is easily formed.

The fluorine atom is introduced, for example, by using a monomer having a fluorine atom as a monomer to be a raw material of the specific acrylic resin. Examples of the monomer having a fluorine atom include 2-(perfluorobutyl)ethyl acrylate, 2-(perfluorobutyl)ethyl methacrylate, 2-(perfluorohexyl)ethyl acrylate, 2-(perfluorohexyl)ethyl methacrylate, perfluorohexylethylene, hexafluoropropene, hexafluoropropene epoxide, perfluoro(propyl vinyl ether) or the like.

The fluorine atom is preferably contained in the side chain of the specific acrylic resin. The number of carbon atoms in the side chain containing a fluorine atom is, for example, 2 to 20. In addition, the carbon chain in the side chain containing a fluorine atom may be a linear or branched chain.

The number of fluorine atoms contained in one molecule of the monomer containing a fluorine atom is not particularly limited, and is preferably 1 to 25, and more preferably 3 to 17.

The proportion of the fluorine atom to the whole specific acrylic resin is preferably 0.1 mass % to 50 mass %, and more preferably 1 mass % to 20 mass %.

Silane Coupling Agent

The specific acrylic resin preferably has a structure derived from a silane coupling agent in the molecular structure thereof. Since the specific acrylic resin has the structure derived from the silane coupling agent, a surface protective resin member having high adhesion to the base material and a low surface friction coefficient is easily formed.

The structure derived from the silane coupling agent in the specific acrylic resin is introduced, for example, by using the silane coupling agent as a monomer to be a raw material of the specific acrylic resin, that is, using the silane coupling agent having a vinyl group (CH₂═C(—R¹¹)— as a monomer. Here, R¹¹ represents a hydrogen atom or an alkyl group having 1 to 8 carbon atoms. A moiety having a silicon atom in the silane coupling agent (a) is introduced into the side chain of the specific acrylic resin by using the silane coupling agent having a vinyl group as a monomer. Accordingly, the moiety having a silicon atom is easy to be exposed on the surface of the surface protective resin member, the base material adhesion is improved, and the friction coefficient of the surface protective resin member is more easily reduced.

It is preferable that the number of the vinyl group of the silane coupling agent having a vinyl group is only one in one molecular structure. Since there is only one vinyl group, in the side chain into which the moiety having a silicon atom is introduced, one side thereof (the side opposite to the side bonded to the main chain of the acrylic resin) is not fixed. Therefore, the easiness of movement of the side chain is further improved, the moiety having a silicon atom is more easily exposed on the surface of the surface protective resin member, the base material adhesion is improved, and the friction coefficient of the surface protective resin member is more easily reduced.

Examples of the silane coupling agent having a vinyl group include a compound having a structure represented by the following General Formula (S1).

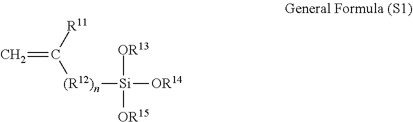

In General Formula (S1), R¹¹ represents a hydrogen atom or an alkyl group having 1 to 8 carbon atoms, R¹² represents a divalent organic group, R¹³, R¹⁴ and R¹⁵ each independently represents a hydrogen atom or an alkyl group having 1 to 5 carbon atoms, and n represents 0 or 1.

The alkyl group represented by R¹¹ may be linear or branched. Examples of the alkyl group include a methyl group, an ethyl group, a butyl group or the like.

R¹¹ is preferably a hydrogen atom or a methyl group.

Examples of the organic group represented by R¹² include a group containing at least one atom selected from a group of atoms consisting of C, H, O, and N. For example, a group such as a divalent hydrocarbon group which may have a hetero atom (for example, an alkylene group), —O—, —C(═O)—, and —C(═O)—O—, or a group formed by combining two or more of these groups.

R¹² may be a group formed by combining: a group selected from any one of —O—, —C(═O)— and —C(═O)—O— (preferably —C(═O)—O—); with a divalent hydrocarbon group which may have a hetero atom (preferably an alkylene group, and more preferably an alkylene group having 2 to 4 carbon atoms). Among these, —COO—(CH₂)₃—, or —COO—(CH₂)₂— is more preferred.

In addition, n is preferably 1.

The alkyl group which represents R¹³, R¹⁴, or R¹⁵, may be linear or branched and may be, for example, a methyl group, an ethyl group, a butyl group or the like.

R¹³, R¹⁴ and R¹⁵ are each independently preferably a hydrogen atom, a methyl group, or an ethyl group.

Examples of the silane coupling agent having a vinyl group include trimethoxysilylpropyl (meth)acrylate, triethoxysilylpropyl (meth)acrylate, trimethoxysilylethyl (meth)acrylate, triethoxysilylethyl (meth)acrylate, or the like.

Among these, trimethoxysilylpropyl (meth)acrylate and triethoxysilylpropyl (meth)acrylate are preferred.

The structure derived from the silane coupling agent is introduced, for example, by reacting a silane coupling agent having a functional group reactive to a hydroxyl group (hereinafter also simply referred to as “hydroxyl group-reactive silane coupling agent”) with a hydroxyl group of the specific acrylic resin. A moiety having a silicon atom in the silane coupling agent is introduced into the side chain of the specific acrylic resin (a) by reacting the hydroxyl group of the specific acrylic resin with the hydroxyl group-reactive silane coupling agent. Accordingly, the moiety having a silicon atom is easy to be exposed on the surface of the surface protective resin member, the adhesion to the base material is improved, and the friction coefficient of the surface protective resin member is more easily reduced.

Examples of the functional group reactive to a hydroxyl group include an isocyanate group (—NCO), a hydroxyl group (—OH), a carboxyl group (—COOH), an epoxy group or the like.

Among these, an isocyanate group is preferred.

It is preferable that the number of the functional group of the hydroxyl group-reactive silane coupling agent is only one in one molecular structure. Since the number of the functional group is only one, one terminal of the side chain into which the moiety having a silicon atom is introduced (the terminal opposite to the side bonded to the main chain of the acrylic resin) is not fixed. Therefore, the easiness of movement of the side chain is further improved, the moiety having a silicon atom is more easily exposed on the surface of the surface protective resin member, the adhesion to the base material is improved, and the friction coefficient of the surface protective resin member is more easily reduced.

Examples of the hydroxyl group-reactive silane coupling agent include a compound having a structure represented by the following General Formula (S2).

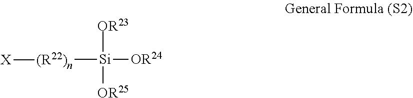

In General Formula (S2), X represents a functional group reactive to a hydroxyl group, R²² represents a divalent organic group, R²³, R²⁴ and R²⁵ each independently represents a hydrogen atom or an alkyl group having 1 to 3 carbon atoms, and n represents 0 or 1.

Examples of the organic group represented by R include a group containing at least one atom selected from the group of atoms consisting of C, H, O, and N. For example, a group such as a divalent hydrocarbon group which may have a hetero atom (for example, an alkylene group), —O—, —C(═O)—, and —C(═O)—O—, or a group formed by combining two or more of these groups.

R²² is preferably a divalent hydrocarbon group which may have a hetero atom (more preferably an alkylene group, and still more preferably an alkylene group having 1 to 10 carbon atoms). Among these, an ethylene group and an n-propylene group are more preferred.

In addition, n is preferably 1.

The alkyl group which represents R²³, R²⁴ and R²⁵ may be linear or branched. Examples of the alkyl group include a methyl group, an ethyl group, a propyl group or the like.

R², R²⁴ and R²⁵ are each independently preferably a hydrogen atom, a methyl group, or an ethyl group.

Examples of the hydroxyl group-reactive silane coupling agent include trimethoxysilylpropyl isocyanate, triethoxysilylpropyl isocyanate, trimethoxysilylethyl isocyanate, triethoxysilylethyl isocyanate, hydroxypropyl trimethoxysilane, hydroxypropyl triethoxysilane, hydroxyethyl trimethoxysilane, hydroxyethyl triethoxysilane, or the like.

Among these, trimethoxysilylpropyl isocyanate and triethoxysilylpropyl isocyanate are preferred.

In a case are the structure derived from the silane coupling agent is introduced into a specific acrylic resin by using at least one of: the silane coupling agent having a vinyl group; and the hydroxyl group-reactive silane coupling agent, the proportion of the silicon atom (Si) is preferably 0.01 mass % to 1 mass %, and more preferably 0.1 mass % to 0.5 mass %, with respect to the entire specific acrylic resin.

Hydroxyl Value

The specific acrylic resin has a hydroxyl value of 40 mgKOH/g to 280 mgKOH/g. The hydroxyl value is more preferably 70 mgKOH/g to 200 mgKOH/g.

When the hydroxyl value is 40 mgKOH/g or more, a polyurethane resin having a high crosslinking density is polymerized, and on the other hand, when the hydroxyl value is 280 mgKOH/g or less, a polyurethane resin having moderate flexibility can be obtained.

The hydroxyl value of the specific acrylic resin is adjusted by the proportion of the monomer having a hydroxyl group in all the monomers synthesizing the specific acrylic resin.

The hydroxyl value represents the mass of potassium hydroxide in milligrams required for acetylating the hydroxyl group in 1 g of the sample. The hydroxyl value in the present embodiment is measured according to the method defined in JIS K 0070-1992 (potentiometric titration method). However, when the sample does not dissolve, a solvent such as dioxane or tetrahydrofuran (THF) is used.

The synthesis of the specific acrylic resin is performed, for example, by mixing the above-mentioned monomers, and performing ordinary radical polymerization, ionic polymerization or the like, and followed by purification.

(b) Long-Chain Polyol

The long-chain polyol is a polyol having a plurality of hydroxyl groups (—OH) bonded via a carbon chain having 6 or more carbon atoms (the number of carbon atoms in the straight chain portion linking the hydroxyl groups). That is, the long-chain polyol is a polyol is a polyol in which all the hydroxyl groups are bonded via a carbon chain having 6 or more carbon atoms (the number of carbon atoms in the straight chain portion linking the hydroxyl groups). The number of functional groups in the long-chain-polyol (that is, the number of hydroxyl groups contained in one molecule of the long-chain polyol) may be, for example, in a range of 2 to 5, or may be in a range of 2 to 3.

The carbon chain having 6 or more carbon atoms in the long-chain polyol represents a carbon chain whose number of carbon atoms in the straight chain portion bonding the hydroxyl groups is 6 or more. Examples of the carbon chain having 6 or more carbon atoms include an alkylene group or a divalent group formed by combining one or more of alkylene groups with one or more groups selected from —O—, —C(═O)—, and —C(═O)—O—. It is preferable that the long-chain polyol having hydroxyl groups linked to each other via a carbon chain having 6 or more carbon atoms has a structure of —[CO(CH₂)ₙ₁O]ₙ₂—H. Here, n1 represents 1 to 10, preferably 3 to 6, and more preferably 5, and n2 represents 1 to 50, preferably 1 to 35, more preferably 1 to 10, and still more preferably 2 to 6.

Examples of the long-chain polyol include a bifunctional polycaprolactone diol, a trifunctional polycaprolactone triol, a tetrafunctional or higher functional polycaprolactone polyol or the like.

Examples of the bifunctional polycaprolactone diol include a compound having two groups each having a hydroxyl group in a terminal. The group having a hydroxy group in a terminal is represented by —[CO(CH₂)ₙ₁₁O]ₙ₁₂—H. Here, n₁₁ represents 1 to 10, preferably 3 to 6, and more preferably 5, and n12 represents 1 to 50, preferably 3 to 35. Among these, the compound represented by the following General Formula (1) is preferred.

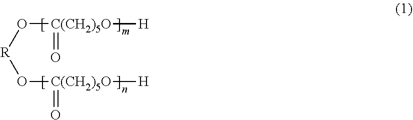

In General Formula (1), R represents an alkylene group or a divalent group formed by combining an alkylene group and one or more groups selected from —O— and —C(═O)—; and m and n each independently represents an integer of 1 to 35.

In General Formula (1), the alkylene group contained in the divalent group represented by R may be linear or branched. The alkylene group is, for example, preferably an alkylene group having 1 to 10 carbon atoms, and more preferably an alkylene group having 1 to 5 carbon atoms.

The divalent group represented by R is preferably a linear or branched alkylene group having 1 to 10 carbon atoms (preferably 2 to 5 carbon atoms), or preferably a group formed by linking two linear or branched alkylene groups having 1 to 5 carbon atoms (preferably 1 to 3 carbon atoms) with —O— or —C(═O)— (preferably —O—). Among these, the divalent groups represented by *—C₂H₄—*, *—C₂H₄OC₂H₄—*, or *—C(CH₃)₂—(CH₂)₂—* are more preferred. The divalent groups listed above are bonded at the “*” part, respectively.

m and n each independently represent an integer of 1 to 35, preferably 2 to 10, and more preferably 2 to 5.

Examples of the trifunctional polycaprolactone triol include a compound having three groups each having a hydroxyl group in a terminal. The group having a hydroxyl group in a terminal is represented by —[CO(CH₂)₂₁O]ₙ₂₂—H. Here, n21 represents 1 to 10, preferably 3 to 6, and more preferably 5, and n22 represents 1 to 50, preferably 1 to 28. Among these, the compound represented by the following General Formula (2) is preferred.

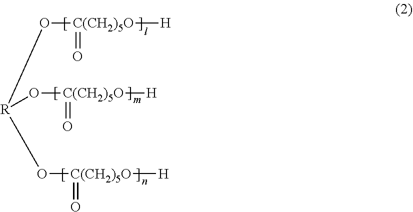

In General Formula (2), R represents a trivalent group formed by removing one hydrogen atom from an alkylene group, or a trivalent group formed by combining a trivalent group formed by removing one hydrogen atom from an alkylene group and one or more groups selected from an alkylene group, —O—, and —C(═O)—. l, m, and n each independently represent an integer of 1 to 28, and 1+m+n is 3 to 30.)

In General Formula (2), in a case where R represents the trivalent group formed by removing one hydrogen atom from an alkylene group, the group may be linear or branched. The trivalent group formed by removing one hydrogen atom from an alkylene group is, for example, preferably an alkylene group having 1 to 10 carbon atoms, and more preferably an alkylene group having 1 to 6 carbon atoms.

The R may be a trivalent group formed by combing the trivalent group formed by removing one hydrogen atom from an alkylene group shown above and one or more groups selected from an alkylene group (for example, an alkylene group having 1 to 10 carbon atoms), —O—, and —C(═O)—.

The trivalent group represented by R is preferably a trivalent group formed by removing one hydrogen atom from a linear or branched alkylene group having 1 to 10 carbon atoms (preferably 3 to 6 carbon atoms). Among these, the trivalent groups represented by *—CH₂—CH(—*)—CH₂—*, CH₃—C(—*)(-*)—(CH₂)₂—*, and CH₃CH₂C(—* )(*)(-*)(CH₂)₃—* are more preferred. The trivalent groups listed above are bonded at the “*” part, respectively.

l, m and n each independently represent an integer of 1 to 28, preferably 2 to 10, and more preferably 2 to 5. I+m+n is 3 to 30, preferably 6 to 30, and more preferably 6 to 20.

A long-chain polyol containing a fluorine atom may be used as the long-chain polyol.

Examples of the long-chain polyol containing a fluorine atom include: a long-chain diol having 6 to 12 carbon atoms (for example, a diol in which two hydroxyl groups are bonded with an alkylene group having 6 to 12 carbon atoms) in which part or all of H atoms bonded to C atoms are replaced by F atoms; a long-chain glycol such as a polyolefin glycol having 6 to 12 carbon atoms (for example, a polyolefin glycol having 6 to 12 carbon atoms which is obtained by polymerizing a plurality of olefin glycols such as ethylene glycol and propylene glycol) in which part or all of H atoms bonded to C atoms are replaced with F atoms, or the like. Specifically, 1H,1H,9H,9H-perfluoro-1,9-nonanediol, fluorinated tetraethylene glycol, 1H,1H,8H,8H-perfluoro-1,8-octanediol or the like can be mentioned.

The long-chain polyol may be used alone only, or may be used in combination of two or more thereof.

The addition amount of the long-chain polyol (b) with respect to the specific acrylic resin (a) may be adjusted such that a ratio [B]/[A] of the total molar amount [B] of the hydroxyl groups contained in the long-chain polyol (b) to the total molar amount [A] of all the hydroxyl groups contained in the specific acrylic resin (a) is in a range of 0.1 to 10, and the range may be 0.1 to 4.

The long-chain polyol preferably has a hydroxyl value of 30 mgKOH/g to 300 mgKOH/g, and more preferably 50 mgKOH/g to 250 mgKOH/g. It is inferred that when the hydroxyl value is 30 mgKOH/g or more, a polyurethane resin having a high crosslinking density is polymerized, and on the other hand, when the hydroxyl value is 300 mgKOH/g or less, a polyurethane resin having moderate flexibility can be obtained.

The above hydroxyl value represents the mass of potassium hydroxide in milligrams required for acetylating the hydroxyl group in 1 g of the sample. The above hydroxyl value in the present embodiment is measured according to the method defined in JIS K 0070-1992 (potentiometric titration method). However, when the sample does not dissolve, a solvent such as dioxane or THF is used as a solvent.

(c) Isocyanate Group Reactive-Silicone Resin

In the present embodiment, a silicone resin having a functional group reactive to an isocyanate group (isocyanate group reactive-silicone resin) is used.

A siloxane bond is introduced into the side chain of the specific acrylic resin (a) by reacting the isocyanate group reactive-silicone resin (c) with the specific acrylic resin (a) via the polyfunctional isocyanate (d), and thus the friction coefficient of the formed surface protective resin member is lowered.

Examples of the functional group reactive to an isocyanate group and included in the isocyanate group reactive-silicone resin include an amino group (—N(—R¹¹)(—R¹²)—, wherein R¹¹ and R¹² each independently represent a hydrogen atom or an alkyl group having 1 to 3 carbon atoms), a hydroxyalkyl group (—R²¹—OH—, wherein R²¹ represents an alkylene group having 1 to 10 carbon atoms), a hydroxyl group (—OH), a carboxyl group (—COOH), an epoxy group, or the like.

Among these, the hydroxyalkyl group or the hydroxyl group is preferred.

The isocyanate group reactive-silicone resin may have only one functional group reactive to an isocyanate group or two or more functional groups reactive to an isocyanate group in one molecular structure.

The number of the functional groups that the isocyanate group reactive-silicone resin has in one molecular structure is not particularly limited. However, a resin having only one functional group reactive to an isocyanate group in one molecular structure is preferred. Since the number of the functional groups contained in one molecular structure is one, only one site where the isocyanate group reactive-silicone resin is bonded and fixed to the specific acrylic resin is obtained. Therefore, the easiness of movement of a chain having a siloxane bond is further improved, the moiety having a silicon atom is more easily exposed on the surface of the surface protective resin member, and the friction coefficient of the surface protective resin member is more easily reduced.

Further, from the viewpoint of more easily lowering the friction coefficient of the surface protective resin member, in a case of having only one functional group reactive to an isocyanate group in one molecular structure, the position having the functional group is more preferably the terminal (one terminal) of the main chain of the silicone resin.

Examples of the isocyanate group reactive-silicone resin include a compound having at least one functional group reactive to an isocyanate group at one or more ends of the main chain of the silicone resin, specifically include a compound having a structure represented by the following General Formula (P1).

Examples thereof also include a compound having a functional group as a part of the side chain of the silicone resin, specifically include a compound having a structure represented by the following General Formula (P2).

The isocyanate group reactive-silicone resin is more preferably a compound having a structure represented by the following General Formula (P1).

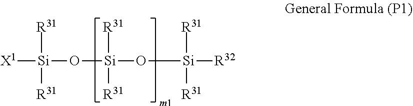

In General Formula (P1), X¹ represents a functional group reactive to an isocyanate group, R³¹ and R³² each independently represents a hydrogen atom, an alkyl group, an aryl group, or a functional group reactive to an isocyanate group, and m1 represents an integer of 1 or more. A plurality of R³¹ present in the General Formula (P1) may be same or different.

In General Formula (P1), the alkyl group represented by R³¹ or R³² may be linear, branched or cyclic. The number of carbon atoms of the alkyl group is preferably 1 to 8, and more preferably 1 to 3. Examples of the alkyl group include a methyl group, an ethyl group, a butyl group or the like. Among these, the methyl group is preferred.

The aryl group represented by R³¹ or R³² preferably has a number of carbon atoms of 4 to 20. Examples of the aryl group include a phenyl group, a tolyl group, a naphthyl group, or the like. Among these, the phenyl group is preferred.

R³¹ is preferably independently a hydrogen atom, a methyl group, an ethyl group, or a phenyl group, and more preferably a methyl group. The plurality of R³ present in General Formula (P1) may be same or different, but preferably all are the same.

R³² is preferably a hydrogen atom, a methyl group, an ethyl group, a phenyl group, or a functional group reactive to an isocyanate group, more preferably a hydrogen atom, a methyl group, an ethyl group, or a phenyl group, and still more preferably a methyl group.

m1 is not particularly limited, and may be, for example, 3 to 1000.

The compound having a structure represented by General Formula (P1) preferably has a structure having the functional group only in X¹ or a structure having the functional group only in X¹ and R³², and more preferably a structure having the functional group only in X¹.

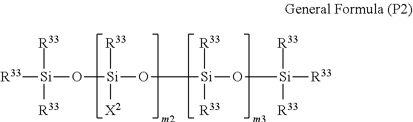

In General Formula (P2). X² represents a functional group reactive to an isocyanate group, R³³ each independently represents a hydrogen atom, an alkyl group, an aryl group, or a functional group reactive to an isocyanate group, and m2 and m3 each independently represent an integer of 1 or more. A plurality of R³³ present in the General Formula (P2) may be same or different.

In General Formula (P2), the alkyl group and the aryl group represented by R³³ having the same meaning with the alkyl group and the aryl group represented by R³² in General Formula (P1).

R³³, each independently, is preferably a hydrogen atom, a methyl group, an ethyl group, a phenyl group, or a functional group reactive to an isocyanate group, more preferably a hydrogen atom, a methyl group, an ethyl group, or a phenyl group, and still more preferably a methyl group. The plurality of R³³ present in General Formula (P2) may be same or different, but preferably all are the same.

The sum of m2 and m3 is not particularly limited, and may be, for example, 3 to 1000.

The compound having a structure represented by General Formula (P2) is preferably a structure having the functional group only in X², and more preferably the number of m2 is 1.

The weight average molecular weight of the isocyanate group reactive-silicone resin is, for example, 250 to 50000, or may be 500 to 20000.

(Ratio of Silicon Atom to Fluorine Atom)

In the solution (A solution) for forming a surface protective resin member according to the present embodiment contains the isocyanate group reactive-silicone resin (c), and the specific acrylic resin (a) may have a structure derived from a silane coupling agent in the molecular structure thereof (for example, at least one of: a structure in which a silane coupling agent having a functional group reactive to a hydroxyl group is bonded to a side chain; and a structure in which a silane coupling agent having a vinyl group is polymerized as a monomer), and the specific acrylic resin (a) may further have a fluorine atom.

In this case, with respect to the total amount of an amount [F₁] of the fluorine atom contained in the specific acrylic resin (a), an amount [Si₂] of the silicon atom contained in the specific acrylic resin (a) and an amount [Si₃] of the silicon atom contained in the isocyanate group reactive-silicone resin (c), the ratios (mass ratios) of the [F₁] and [Si₃] are preferably in the following range, respectively.

The mass ratio [F₁]/([F₁]+[Si₂]+[Si₃]) is preferably 0.1 to 0.95, and more preferably 0.6 to 0.95.

When the mass ratio [F₁]/([F₁]+[Si₂]+[Si₃]) is within the above range, a surface protective resin member having high adhesion to the base material, high surface slipperiness and a high antifouling property can be formed.

The mass ratio [Si₃]/([F₁]+[Si₂]+[Si₃]) is preferably 0.01 to 0.9, and more preferably 0.03 to 0.6.

When the mass ratio [Si₃]/([F₁]+[Si₂]+[Si₃]) is within the above range, a surface protective resin member having high adhesion to the base material, high surface slipperiness and a high antifouling property can be formed.

### <Solution Set for Forming Surface Protective Resin Member>

The solution set for forming a surface protective resin member according to the present embodiment contains a first solution containing the solution (A solution) for forming a surface protective resin member according to the present embodiment as described above, and a second solution (B solution) containing a polyfunctional isocyanate.

(d) Polyfunctional Isocyanate

The polyfunctional isocyanate (d) is a compound having a plurality of isocyanate groups (—NCO), and reacts with, for example, the hydroxyl group of the specific acrylic resin (a), the hydroxyl group of the long-chain polyol (b), the functional group reactive to the isocyanate group of the silicone resin (c), or the like. In addition, the polyfunctional isocyanate functions as a crosslinking agent for crosslinking between specific acrylic resins (a), between the specific acrylic resin (a) and the long-chain polyol (b), between the specific acrylic resin (a) and the isocyanate group reactive-silicone resin (c), between long-chain polyols (b), between the long-chain polyol (b) and the isocyanate group reactive-silicone resin (c), and between the isocyanate group reactive-silicone resins (c).

Examples of the polyfunctional isocyanate are not particularly limited and include a bifunctional diisocyanate such as methylene diisocyanate, toluene diisocyanate, hexamethylene diisocyanate, and isophorone diisocyanate. In addition, a multimer of hexamethylene polyisocyanate having a burette structure, an isocyanurate structure, an adduct structure, an elastic structure, or the like may be also preferably used.

Commercially available polyfunctional isocyanate may be used, for example, polyisocyanate (DURANATE) manufactured by Asahi Kasei Corporation.

Only one type of the polyfunctional isocyanate may be used, or two or more types thereof may be used by mixing.

(e) Other Additives

In the present embodiment, other additives in addition to the first solution (A solution) and the second solution (B solution) may be contained. For example, examples of the other additives include an antistatic agent, a reaction accelerator for accelerating the reaction between the hydroxyl groups (—OH) in the specific acrylic resin (a) and in the long-chain polyol (b) and the isocyanate groups (—NCO) in the polyfunctional isocyanate (d), or the like.

Antistatic Agent

Specific examples of the antistatic agent include cationic surface active compounds (e.g., a tetraalkylammonium salt, a trialkylbenzylammonium salt, an alkylamine hydrochloride, and an imidazolium salt), anionic surface active compounds (e.g., an alkyl sulfonate, an alkyl benzene sulfonate, and an alkyl phosphate), nonionic surfactant compounds (e.g., glycerin fatty acid ester, polyoxyalkylene ether, polyoxyethylene alkyl phenyl ether, N,N-bis-2-hydroxyethylalkylamine, hydroxyalkyl monoethanolamine, polyoxyethylene alkylamine, fatty acid diethanolamide, and polyoxyethylene alkylamine fatty acid ester), amphoteric surfactant compounds (e.g., alkyl betaine and alkyl imidazolium betaine), or the like.

In addition, examples of the antistatic agent include those containing quaternary ammonium.

Specifically, examples include tri-n-butylmethylammonium bistrifluoromethanesulfonimide, lauryl trimethyl ammonium chloride, octyldimethyl ethyl ammonium ethyl sulphate, didecyl dimethyl ammonium chloride, lauryl dimethyl benzyl ammonium chloride, stearyl dimethyl hydroxyethyl ammonium para-toluene sulfonate, tributylbenzylammonium chloride, lauryldimethylaminoacetic acid betaine, lauric acid amidopropyl betaine, octanoic acid amidopropyl betaine, polyoxyethylene stearylamine hydrochloride, or the like. Among these, tri-n-butylmethylammonium bistrifluoromethanesulfonimide is preferred.

In addition, an antistatic agent having a high molecular weight may be used.

Examples of the antistatic agent having a high molecular weight include a polymer compound obtained by polymerizing a quaternary ammonium base-containing acrylate, a polymer compound based on polystyrene sulfonic acid, a polymer compound based on polycarboxylic acid, a polyetherester-based polymer compound, a polymer compound based on ethylene oxide-epichlorohydrin, a polyetheresteramide-based polymer compound, or the like.

Examples of the polymer compound obtained by polymerizing a quaternary ammonium base-containing acrylate include a polymer compound having at least the following structural unit (A).

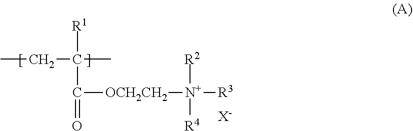

In structural unit (A), R¹ represents a hydrogen atom or a methyl group, R², R³ and R⁴ each independently represents an alkyl group, and X⁻ represents an anion.

The polymerization of the antistatic agent having a high molecular weight can be performed by a known method.

As the antistatic agent having a high molecular weight, only a polymer compound composed of the same monomers may be used, or two or more of polymer compounds composed of different monomers may be used in combination.

It is preferable to adjust the surface resistance of the surface protective resin member formed in the present embodiment to be in the range of 1×10⁹ Ω/□ to 1×10¹⁴Ω/□, and to adjust the volume resistance thereof to be in the range of 1×10⁸ Ωcm to 1×10¹³ Ωcm.

The surface resistance and the volume resistance are measured in accordance with JIS-K6911 under the environment of 22° C. and 55% RH using a HIRESTA UP MCP-450 UR probe manufactured by Dia Instruments Co., Ltd.

The surface resistance and the volume resistance of the surface protective resin member are controlled by adjusting the type, content, or the like of the antistatic agent as long as the antistatic agent is contained.

The antistatic agent may be used alone, or may be used in combination of two or more thereof.

Reaction Accelerator

Examples of the reaction accelerator for accelerating the reaction between the hydroxyl groups (—OH) in the specific acrylic resin (a) and in the long-chain polyol (b) and the isocyanate groups (—NCO) in the polyfunctional isocyanate (d) include a metal catalyst of tin or bismuth. For examples, NEOSTANN U-28, U-50, U-600 and tin (II) stearate manufactured by NITTO KASEI Co., Ltd., can be mentioned. In addition, XC-C277 and XK-640 manufactured by Kusumoto Chemicals, Ltd. can be mentioned.

### <Surface Protective Resin Member>

The surface protective resin member according to the present embodiment can be formed by mixing and curing the first solution (A solution) and the second solution (B solution) in the solution set for forming a surface protective resin member according to the above embodiment.

In addition, the surface protective resin member can be formed by reacting and curing an acrylic resin having a hydroxyl value of 40 mgKOH/g to 280 mgKOH/g (specific acrylic resin (a)), a polyol having a plurality of hydroxyl groups bonded via a carbon chain having 6 or more carbon atoms (long-chain polyol (b)), a silicone resin having a functional group reactive to an isocyanate group (isocyanate group reactive-silicone resin (c)), and a polyfunctional isocyanate (multifunctional isocyanate (d)), without limiting the case of using the first solution (A solution) and second solution (B solution).

Here, a method of forming the surface protective resin member (a polymerization method of the resin) according to the present embodiment will be described by giving a specific example.

For example, the A solution containing the specific acrylic resin (a), the long-chain polyol (b), and the isocyanate group reactive-silicone resin (c) and the B solution containing the polyfunctional isocyanate (d) are prepared. The A solution and the B solution are mixed, the mixed solution is defoamed under reduced pressure, and then the mixed solution is casted on a base material (for example, a polyimide film, an aluminum plate, and a glass plate) to form a resin layer. Next, the mixed solution is heated (for example, at 85° C. for 60 minutes, and then at 160° C. for 0.5 hours) and cured to form the surface protective resin member.

However, in the present embodiment, the method of forming the surface protective resin member is not limited to the above method. For example, in a case of using a blocked polyfunctional isocyanate, it is preferable to cure by heating at a temperature at which the block is detached. Alternatively, the polymerization may be performed by methods of using ultrasonic waves instead of defoaming under reduced pressure, or allowing the mixed solution to stand for defoaming.

The thickness of the surface protective resin member is not particularly limited, and may be, for example, 1 μm to 100 μm, and may be 10 μm to 30 μm.

Martens Hardness

The surface protective resin members according to the present embodiment preferably have a Martens hardness at 23° C. of 0.5 N/mm² to 220 N/mm², more preferably 1 N/mm² to 80 N/mm², still more preferably 1 N/mm² to 70 N/mm², and even more preferably 1 N/mm² to 5 N/mm². When the Martens hardness at 23° C. is 0.5 N/mm² or more, the shape required for the resin member can be easily maintained. On the other hand, when the Martens hardness at 23° C. is 220 N/mm² or less, the ease of repairing a scratch (that is, self-repairing property) is easily improved.

Return Rate

The surface protective resin member according to the present embodiment preferably has a return rate at 23° C. of 70% to 100%, more preferably 80% to 100%, and even more preferably 90% to 100%. The return rate is an index indicating the self-repairing property of the resin material (the property of restoring the strain generated by the stress within 1 minute after unloading the stress, that is, the degree of repairing a scratch). That is, when the return rate (23° C.) is 70% or more, the ease of repairing a scratch (that is, self-repairing property) is improved.

The Martens hardness and the return rate of the surface protective resin member are adjusted, for example, by controlling the hydroxyl value of the specific acrylic resin (a), the number of carbon atoms in the chain linking the hydroxyl groups in the long-chain polyol (b), the ratio of the long-chain polyol (b) with respect to the specific acrylic resin (a), the number of functional groups (isocyanate groups) in the polyfunctional isocyanate (d), and the ratio of the polyfunctional isocyanate (d) with respect to the specific acrylic resin (a).

The Martens hardness and the return rate is measured by using FISCHER SCOPE HM 2000 (manufactured by Fischer Instruments Co., Ltd.) as a measuring device, fixing a surface protective resin member (sample) to a slide glass with an adhesive and setting the two in the above measuring device. The surface protective resin member is loaded up to 0.5 mN for 15 seconds at a specific measurement temperature (23° C., for example), and held at 0.5 mN for 5 seconds. The maximum displacement at this time is set to be (h1). Thereafter, the load is reduced to 0.005 mN for 15 seconds, and held at 0.005 mN for 1 minute. The displacement when held at 0.005 mN for 1 minute is set to be (h2). Then the return rate [(h1−h2)/h1]×100(%) is calculated. From the load displacement curve during the loading, the Martens hardness can be obtained.

### [Application]

The surface protective resin member according to the present embodiment can be used as a surface protective member for an object having a possibility of causing scratches on the surface due to contact with foreign matter, for example.

Specifically, the surface protective resin member can be applied in screens and bodies other than screens in portable devices (e.g., mobile phones, and portable game machines), screens of touch panels, building materials (e.g., flooring materials, tiles, wall materials, and wallpaper), automobile members (e.g., car interiors, car bodies, and door handles), storage containers (e.g., suitcases), cosmetic containers, eyeglasses (e.g., frames and lenses), sporting goods (e.g., golf clubs and rackets), writing utensils (e.g., fountain pens), musical instruments (e.g., an exterior of a piano), clothes storage tool e.g., hanger), members for an image forming device such as a copying machine (e.g., a transfer member such as a transfer belt), leather goods (e.g., bags and school bags), decorative films, film mirrors, or the like.

### EXAMPLE

Hereinafter, exemplary embodiments of the present invention are described in more detail with reference to Examples and Comparative Examples, but the present invention is not limited to the following examples. In the following, “part” is on a mass basis unless otherwise specified particularly.

### Example 1

### <Synthesis of Acrylic Resin Prepolymer A1>

Monomers of n-butyl methacrylate (nBMA), hydroxyethyl methacrylate (HEMA), fluorine atom-containing acrylic monomer (FAMAC 6, manufactured by UNIMATEC CO., LTD.), and trimethoxysilylpropyl (meth)acrylate (a silane coupling agent, KBM 503, manufactured by Shin-Etsu Chemical Co., Ltd.) are mixed in a molar ratio of 2.5:3:0.5:0.3. Further, a monomer solution is prepared by adding a polymerization initiator (azobisisobutyronitrile (AIBN)) having a monomer ratio of 2 mass % and methyl ethyl ketone (MEK) having a monomer ratio of 40 mass %.

The monomer solution is charged into a dropping funnel and added dropwise to 50 mass % in proportion to monomers of MEK, heated to 80° C. under a nitrogen reflux, during stirring over 3 hours for polymerization. Further, a solution containing 10 mass % in proportion to monomers of MEK and 0.5 mass % in proportion to monomers of AIBN is added dropwise over 1 hour to complete the reaction. During the reaction, the temperature is kept at 80° C. and stirring is continued. Thus, an acrylic resin prepolymer A1 is synthesized.

The hydroxyl value of the obtained acrylic resin prepolymer A1 is measured according to the method defined in JIS K 0070-1992 (potentiometric titration method), and as a result, the hydroxyl value is 165 mgKOH/g.

### <Preparation of A1 Solution>

The following components are mixed to prepare an A1 solution.
Acrylic resin prepolymer A1 solution (solid content of 50 mass %): 4.0 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 3.5 parts
One-end modified silicone resin having a hydroxyl group (X-22-170 BX manufactured by Shin-Etsu Chemical Co., Ltd., having a hydroxyl value of 20 mgKOH/g): 0.2 part

The mass ratio [F₁]/([F₁]+[Si₂]+[Si₃]) of the amount [F₁] of the fluorine atom contained in the acrylic resin prepolymer A1 and the mass ratio [Si₃]/([F₁]+[Si₂]+[Si₃]) of the amount [Si₃] of the silicon atom contained in the silicone resin to the total amount of the amount [F₁], the amount [Si₂] of the silicon atom contained in the acrylic resin prepolymer A1, and the amount [Si₃] are shown in Table 1 below.

### <Formation of Resin Layer A1>

The following B1 solution is added to the following A1 solution and defoamed under reduced pressure for 10 minutes. The resultant is casted on a 90 μm-thick polyimide film and cured at 85° C. for 1 hour and then at 130° C. for 30 minutes to obtain a resin layer A1 with a film thickness of 40 μm.
The A1 solution: 7.7 parts
B1 solution (isocyanate, DURANATE TPA 100, manufactured by Asahi Kasei Chemicals Corporation, compound name: polyisocyanurate form of hexamethylene diisocyanate): 4.3 parts

### Example 2

### <Preparation of A2 Solution>

The following components are mixed to prepare an A2 solution.
Acrylic resin prepolymer A1 solution (solid content of 50 mass %): 4.0 parts
Long-chain polyol (polycaprolactone triol, PLACCEL 312, manufactured by Daicel Corporation, having a molecular weight of 1250 and a hydroxyl value of 130 mgKOH/g to 140 mgKOH/g): 5.0 parts
One-end modified silicone resin having a hydroxyl group (X-22-170 BX manufactured by Shin-Etsu Chemical Co., Ltd., having a hydroxyl value of 20 mgKOH/g): 0.5 part

### <Formation of Resin Layer A2>

The following B2 solution is added to the following A2 solution and defoamed under reduced pressure for 10 minutes. The resultant is casted on a 90 Gm-thick polyimide film and cured at 85° C. for 1 hour and then at 130° C. for 30 minutes to obtain a resin layer A2 with a film thickness of 40 μm.
The A2 solution: 9.5 parts
B2 solution (isocyanate, DURANATE TPA 100, manufactured by Asahi Kasei Chemicals Corporation, compound name: polyisocyanurate form of hexamethylene diisocyanate): 4.8 parts

### Example 3

### <Preparation of A3 Solution>

The following components are mixed to prepare an A3 solution.
Acrylic resin prepolymer A1 solution (solid content of 50 mass %): 4.0 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 3.5 parts
Both-end modified silicone resin having a hydroxyl group (KF-6003 manufactured by Shin-Etsu Chemical Co., Ltd., having a hydroxyl value of 22 mgKOH/g): 0.2 part

### <Formation of Resin Layer A3>

The following B3 solution is added to the following A3 solution to prepare a resin layer in the same manner as the resin layer A2.
The A3 solution: 7.71 parts
B3 solution (isocyanate, DURANATE TPA 100, manufactured by Asahi Kasei Chemicals Corporation, compound name: polyisocyanurate form of hexamethylene diisocyanate): 4.3 parts

### Example 4

<Synthesis of Acrylic Resin Prepolymer A1 l>

Monomers of n-butyl methacrylate (nBMA), hydroxyethyl methacrylate (HEMA), and trimethoxysilylpropyl (meth)acrylate (a silane coupling agent, KBM 503, manufactured by Shin-Etsu Chemical Co., Ltd.) are mixed in a molar ratio of 3:3:0.3.

Except the above, an acrylic resin prepolymer A11 is synthesized in the same manner as the synthesis of the acrylic resin prepolymer A1.

The hydroxyl value of the obtained acrylic resin prepolymer A11 is measured according to the method (potentiometric titration method) defined in JIS K 0070-1992, and as a result, the hydroxyl value is 199 mgKOH/g.

### <Preparation of A11 Solution>

The following components are mixed to prepare an A11 solution.
Acrylic resin prepolymer A11 solution (solid content of 50 mass %): 4.0 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 5.0 parts
One-end modified silicone resin having a hydroxyl group (X-22-170 BX manufactured by Shin-Etsu Chemical Co., Ltd., having a hydroxyl value of 20 mgKOH/g): 0.2 part

### <Formation of Resin Layer A11>

The following B11 solution is added to the following A11 solution to prepare a resin layer in the same manner as the resin layer A2.
The above A11 solution: 9.2 parts
B11 solution (isocyanate, DURANATE TPA 100, manufactured by Asahi Kasei Chemicals Corporation, compound name: polyisocyanurate form of hexamethylene diisocyanate): 5.5 parts

### Example 5

### <Synthesis of Acrylic Resin Prepolymer A12>

Monomers of n-butyl methacrylate (nBMA), hydroxyethyl methacrylate (HEMA) and fluorine atom-containing acrylic monomer (FAMAC 6, manufactured by UNIMATEC CO., LTD.) are mixed in a molar ratio of 2.5:3:0.5.

Except the above, an acrylic resin prepolymer A12 is synthesized in the same manner as the synthesis of the acrylic resin prepolymer A1.

The hydroxyl value of the obtained acrylic resin prepolymer A12 is measured according to the method (potentiometric titration method) defined in JIS K 0070-1992, and as a result, the hydroxyl value is 175 mgKOH/g.

### <Preparation of A12 Solution>

The following components are mixed to prepare an A12 solution.
Acrylic resin prepolymer A12 solution (solid content of 50 mass %): 4.0 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 3.5 parts
One-end modified silicone resin having a hydroxyl group (X-22-170 BX manufactured by Shin-Etsu Chemical Co., Ltd., having a hydroxyl value of 20 mgKOH/g): 0.2 part

### <Formation of Resin Layer A12>

The following B12 solution is added to the following A12 solution to prepare a resin layer in the same manner as the resin layer A2.
The above A12 solution: 7.7 parts
B12 solution (isocyanate, DURANATE TPA 100, manufactured by Asahi Kasei Chemicals Corporation, compound name: polyisocyanurate form of hexamethylene diisocyanate): 4.2 parts

### Comparative Example 1

### <Preparation of A4 Solution>

The following components are mixed to prepare an A4 solution.
Acrylic resin prepolymer A1 solution (solid content of 50 mass %): 4.0 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 3.5 parts

### <Formation of Resin Layer A4>

The following B4 solution is added to the following A4 solution and defoamed under reduced pressure for 10 minutes. The resultant is casted on a 90 μ-thick polyimide film and cured at 85° C. for 1 hour and then at 130° C. for 30 minutes to obtain a resin layer A4 with a film thickness of 40 μm.
The above A4 solution: 7.5 parts
B4 solution (isocyanate, DURANATAE TPA 100, manufactured by Asahi Kasei Chemicals Corporation, compound name: polyisocyanurate form of hexamethylene diisocyanate): 3.9 parts

### [Evaluation on Resin Layer]

### —Martens Hardness and Return Rate at 23° C.—

The return rate and Martens hardness are measured for each of the resin layers obtained in the above Examples and Comparative Examples by the following methods. The results are shown in Table 1.

FISCHER SCOPE HM 2000 (manufactured by Fischer Instruments Co., Ltd.) is used as a measuring device, the obtained resin layer is fixed to a slide glass with an adhesive and the two are set in the above measuring device. The resin layer is loaded with 0.5 mN at room temperature (23° C.) over a period of 15 seconds and held at 0.5 mN for 5 seconds. The maximum displacement at this time is set to be (h1). Thereafter, the load is reduced to 0.005 mN for 15 seconds, and the return rate “[(h1−h2)/h1]×100(%)” is calculated, (h2) being the displacement when held at 0.005 mN for 1 minute. From the load displacement curve at this time, the Martens hardness is obtained.

### —Dynamic Friction Coefficient for Sapphire Needle—

The friction coefficient is measured for each of the resin layers obtained in the above Examples and Comparative Examples by the following methods. The results are shown in Table 1.

A scratch needle (made of sapphire, tip radius r=0.1 mm) is reciprocated 30 mm at a speed of 10 mm/1 sec on the surface of the resin layer while applying a vertical load of 10 g to 30 g. During the reciprocating, the dynamic friction resistance in the scanning direction applied to the scratch needle is measured using a load variation type friction wear test system, HEIDON TRIBOGEAR HHS 2000 (manufactured by Shinto Scientific Co., Ltd.), and the dynamic friction coefficient is calculated accordingly.

TABLE 1

| | Silicone resin | F—Si ratio | | Martens | Return | |
|---|---|---|---|---|---|---|
| | having OH | [F₁]/([F₁] + | [Si₃]/([F₁] + | hardness | rate | Friction |
| | group | [Si₂] + Si₃]) | [Si₂] + [Si₃]) | [N/mm²] | [%] | coefficient |
| Example 1 | Yes | 0.74 | 0.15 | 2.8 | 92 | 0.4 |
| Example 2 | Yes | 0.61 | 0.3 | 2.7 | 94 | 0.3 |
| Example 3 | Yes | 0.74 | 1 | 2.7 | 92 | 0.9 |
| Example 4 | Yes | 0 | 0.15 | 3.1 | 91 | 0.6 |
| Example 5 | Yes | 0.83 | 0.17 | 2.8 | 90 | 0.45 |
| Comparative | No | — | — | 2.7 | 94 | 3 |
| Example 1 | | | | | | |

As shown in Table 1, it is seen that, in Examples in which a resin member is formed using a solution (A solution) containing an acrylic resin having a hydroxyl value of 40 mgKOH/g to 280 mgKOH/g, a polyol having a plurality of hydroxyl groups bonded via a carbon chain having 6 or more carbon atoms, and a silicone resin having a functional group reactive to an isocyanate group, a surface protective resin member having a self-repairing property and a low surface friction coefficient can be obtained, compared with the Comparative Example in which a resin member is formed using a solution (solution A) not containing a silicone resin having a functional group reactive to an isocyanate group.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A solution for forming a surface protective resin member, comprising:
an acrylic resin having a hydroxyl value of 40 to 280;
a polyol having a plurality of hydroxyl groups bonded via a carbon chain having 6 or more carbon atoms; and
a silicone resin having a functional group reactive to an isocyanate group.

2. The solution for forming a surface protective resin member according to claim 1, wherein the silicone resin has only one functional group reactive to an isocyanate group for each molecular structure.

3. The solution for forming a surface protective resin member according to claim 1, wherein the functional group of the silicone resin is at least one group selected from the group consisting of: an amino group, a hydroxyalkyl group, a hydroxyl group, a carboxyl group, and an epoxy group.

4. The solution for forming a surface protective resin member according to claim 1, wherein the acrylic resin has a structure in which a silane coupling agent having a functional group reactive to a hydroxyl group is bonded to a side chain.

5. The solution for forming a surface protective resin member according to claim 1, wherein the acrylic resin has a structure in which a silane coupling agent having a vinyl group is polymerized as a monomer.

6. The solution for forming a surface protective resin member according to claim 1, wherein the acrylic resin has a fluorine atom.

7. The solution for forming a surface protective resin member according to claim 1, wherein the acrylic resin has at least one structure of:
a structure in which a silane coupling agent having a functional group reactive to a hydroxyl group is bonded to a side chain; and
a structure in which a silane coupling agent having a vinyl group is polymerized as a monomer, and
the acrylic resin has a fluorine atom, and
the acrylic resin satisfies the following formula:
0.1≤[F₁]/([F₁]+[Si₂]+[Si₃])≤0.95
wherein [F₁] is an amount of the fluorine atom contained in the acrylic resin,
[Si₂] is an amount of a silicon atom contained in the acrylic resin, and
[Si₃] is an amount of a silicon atom contained in the silicone resin.

8. The solution for forming a surface protective resin member according to claim 1, wherein the acrylic resin has at least one structure of:
a structure in which a silane coupling agent having a functional group reactive to a hydroxyl group is bonded to a side chain; and
a structure in which a silane coupling agent having a vinyl group is polymerized as a monomer, and
the acrylic resin has a fluorine atom, and
the acrylic resin satisfies the following formula:
0.01≤[Si₃]/([F₁]+[Si₂]+[Si₃])≤0.9
wherein [F₁] is an amount of the fluorine atom contained in the acrylic resin,
[Si₂] is an amount of a silicon atom contained in the acrylic resin, and
[Si₃] is an amount of a silicon atom contained in the silicone resin.

9. A solution set for forming a surface protective resin member, containing:
a first solution containing the solution according to claim 1; and
a second solution containing a multifunctional isocyanate.

10. The solution set for forming a surface protective resin member according to claim 9, wherein at least one of the first solution and the second solution contains an antistatic agent.

11. The solution set for forming a surface protective resin member according to claim 9, wherein at least one of the first solution and the second solution contains a reaction accelerator for accelerating a reaction between the hydroxyl groups in the acrylic resin and the polyol and the isocyanate groups in the polyfunctional isocyanate.

12. A surface protective resin member that is a cured product of:
an acrylic resin having a hydroxyl value of 40 to 280;
a polyol having a plurality of hydroxyl groups bonded via a carbon chain having 6 or more carbon atoms;
a silicone resin having a functional group reactive to an isocyanate group; and
a polyfunctional isocyanate.

13. The surface protective resin member according to claim 12, wherein the Martens hardness at 23° C. is 0.5 N/mm² to 220 N/mm² and the return rate at 23° C. is 70% to 100%.

14. The solution for forming a surface protective resin member according to claim 2, wherein the functional group reactive to an isocyanate group is selected from the group consisting of: an amino group, a hydroxyalkyl group, a hydroxyl group, a carboxyl group, and an epoxy group.

15. The solution for forming a surface protective resin member according to claim 2, wherein the acrylic resin has a structure in which a silane coupling agent having a functional group reactive to a hydroxyl group is bonded to a side chain.

16. The solution for forming a surface protective resin member according to claim 3, wherein the acrylic resin has a structure in which a silane coupling agent having a functional group reactive to a hydroxyl group is bonded to a side chain.

17. The solution for forming a surface protective resin member according to claim 2, wherein the acrylic resin has a structure in which a silane coupling agent having a vinyl group is polymerized as a monomer.

18. The solution for forming a surface protective resin member according to claim 3, wherein the acrylic resin has a structure in which a silane coupling agent having a vinyl group is polymerized as a monomer.

19. The solution for forming a surface protective resin member according to claim 4, wherein the acrylic resin has a structure in which a silane coupling agent having a vinyl group is polymerized as a monomer.

20. The solution for forming a surface protective resin member according to claim 2, wherein the acrylic resin has a fluorine atom.
